(19) United States
(12) Patent Application Publication
(10) Pub. No.: US 2006/0276964 A1
(43) Pub. Date: Dec. 7, 2006

(54) Behavior detector and behavior detection method for a vehicle

(75) Inventor: Yasuhito Sano, Yokohama-shi (JP)

Correspondence Address: YOUNG & BASILE, P.C., 3001 WEST BIG BEAVER ROAD, SUITE 624, TROY, MI, 48084, US

(73) Assignee: Nissan Motor Co., Ltd., Yokohama-shi (JP)

(21) Appl. No.: 11/443,675

(22) Filed: May 31, 2006

(30) Foreign Application Priority Data
Jun. 1, 2005 (JP) JP2005-161438

(51) Int. Cl. G08G 1/16

(52) U.S. Cl. 701/300; 701/301

(57) ABSTRACT

A behavior detector and a behavior detection method for a vehicle. A controller extracts multiple characteristic points out of an image captured using a camera and computes the velocities and the directions that the respective extracted characteristic points move in the image. Then, the controller computes the times (TTC) until vehicle collision with the respective characteristic points based on the computed velocities and the directions that the respective extracted characteristic points move in the image. Distant characteristic points are designated based on the computed TTCs, and movements of the distant characteristic points are monitored in order to detect pitching and yawing of the vehicle.

### TECHNICAL FIELD

The present invention pertains to a behavior detector and a behavior detection method for a vehicle.

### BACKGROUND

An approach detector is known through, for example, Japanese Kokai Patent Application No. 2003-51016. According to the approach detector taught therein, because an image captured in front of a vehicle shows little movement near the optical axis of a camera due to the forward movement of the vehicle, swaying of the image near the optical axis is detected in order to detect changes in the behavior of the vehicle associated with the occurrence of yawing or pitching.

### BRIEF SUMMARY OF THE INVENTION

Embodiments of the invention provide a behavior detector for a vehicle and a behavior detection method for a vehicle. A behavior detector includes, by example, an image pickup device for sequentially capturing a plurality of images outside the vehicle and a controller. The controller is operable to extract characteristic points from each of the plurality of images, to compute movement information for the characteristic points moving through the plurality of images, to compute a time until collision of the vehicle with each of the characteristic points based on the movement information, and to designate certain of the characteristic points at distant positions from the vehicle as distant characteristic points using the respective times until collision. Movements of the distant characteristic points indicate behavior of the vehicle.

A behavior detection method for a vehicle can include, for example, sequentially capturing a plurality of images outside the vehicle, extracting characteristic points from each of the plurality of images, computing movement information for the characteristic points moving through the plurality of images, computing a time until collision of the vehicle with each of the characteristic points based on the movement information, and designating certain of the characteristic points at distant positions from the vehicle as distant characteristic points using the respective times until collision. Movements of the distant characteristic points indicate behavior of the vehicle.

### BRIEF DESCRIPTION OF THE DRAWINGS

The description herein makes reference to the accompanying drawings wherein like reference numerals refer to like parts throughout the several views, and wherein:

FIG. 1 is a block diagram showing an example configuration for implementing a vehicular behavior detector;

FIG. 2 is a diagram showing an example of detection results of characteristic points in an image;

FIG. 3 is a graph showing the relationship among a vanishing point, a positional vector of a characteristic point in the image, a focal point of camera, a distance to the characteristic point in real space, and a positional vector of the characteristic point in real space;

FIG. 4 is a diagram showing an example in which characteristic points with the same time to collision are extracted from an image;

FIG. 5 is a diagram showing an example in which a distant candidate group is extracted from an image;

FIG. 6 is a diagram showing an example in which nearby characteristic points are deleted from a distant candidate group;

FIG. 7 is a diagram showing an example in which movement of a distant characteristic point is measured in order to detect pitching and yawing of the vehicle; and

FIG. 8 is a flow chart showing the processing carried out by a vehicular behavior detector.

### DETAILED DESCRIPTION OF EMBODIMENTS OF THE INVENTION

In the approach described above, because swaying of the image near the optical axis of the camera is detected, even if a moving object is present near the optical axis of the camera while the behavior of the moving object changes, it can be mistakenly detected as a change in the behavior of the vehicle.

In contrast herein, multiple characteristic points are extracted from an image captured by pickup means, pieces of velocity information regarding the respective extracted characteristic points are computed, the times until vehicle collision with the respective characteristic points are computed based on the computed pieces of velocity information on the image. Characteristic points present at a prescribed distance or farther away from the vehicle are designated as distant characteristic points based on these times until collision, and movements of the distant characteristic points are monitored in order to detect behavioral changes of the vehicle. Accordingly, changes in vehicle behavior, such as pitching and yawing of a vehicle, can be detected very accurately without being affected by changes in the behavior of a nearby moving object.

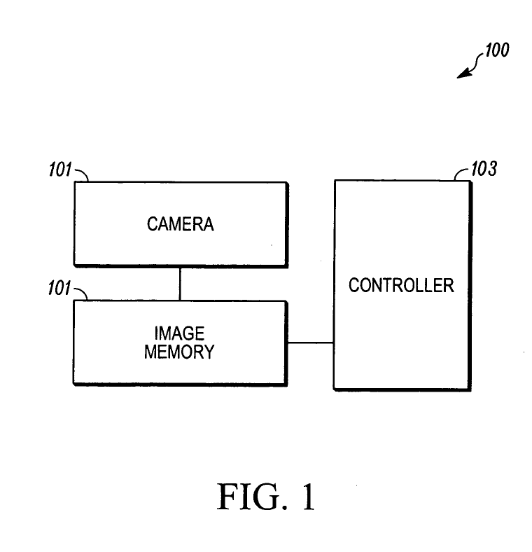

Features of the vehicular behavior detector taught herein can be explained with reference to the drawing figures. FIG. 1 is a block diagram showing an example configuration for implementing the vehicular behavior detector. Vehicular behavior detector 100 is mounted on a vehicle. It includes camera 101 for capturing, or picking up, an image in front of the vehicle, image memory 102 for storing the image captured by camera 101 and a controller 103, which includes generally a CPU, a memory and other peripheral circuits. The controller 103 executes various image processing functions such a detecting characteristic points, computing image velocity, computing time-until-collision, designating characteristic points and detecting behavior as to be described in more detail hereinafter.

Camera 101 can be a high-speed camera equipped with a pickup element such as a CCD or a CMOS, whereby it continuously captures images outside the vehicle at fixed small time intervals Δt, for example, at 2 ms intervals, and outputs an image to image memory 102 for each frame.

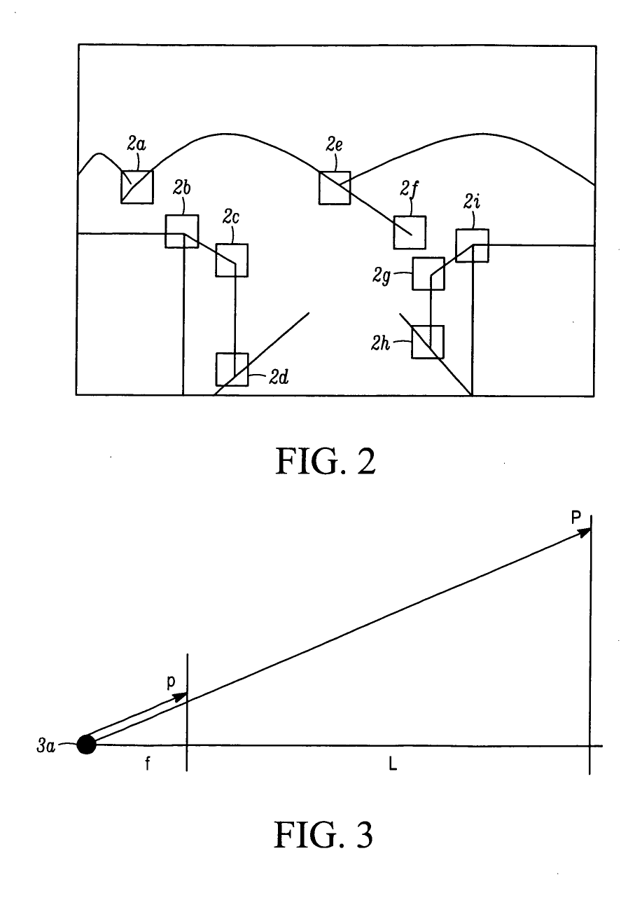

Controller 103 applies image processing to the image (i.e., the pickup image) captured by camera 101 in order to detect pitching and yawing of the vehicle. First, it applies edge extraction processing to the pickup image in order to detect end-points of the extracted edges as characteristic points. That is, it detects points where the edges are disconnected in all the edges extracted within the pickup image in order to detect prescribed ranges of areas that include these points as characteristic points. As a result, as shown in FIG. 2, characteristic points 2a through 2i can be detected within the pickup image.

Detection of characteristic points is carried out for each image frame captured at fixed time intervals Δt in order to track detected characteristic points 2a through 2i. In the present embodiment, characteristic points 2a through 2i are tracked by means of the known sum of absolute difference (SAD) technique. That is, the following processing is carried out. First, the positions where detected characteristic points 2a through 2i are present on the image are stored as a template into a memory of controller 103. Then, when characteristic point 2a is to be tracked, for example, an area with a minimum difference in brightness from that of characteristic point 2a in the template is sought in those pickup images input continuously around the position in the image where characteristic point 2a was present in the previous image.

If an area with a minimum difference in brightness from that of characteristic point 2a in the template is found as a result, tracking is pursued, assuming that characteristic point 2a in the previous image has moved to the detected area. However, if no area with a minimum difference in brightness from that of characteristic point 2a in the template is found, a decision is made that characteristic point 2a has vanished from the pickup image. Characteristic points 2a through 2i can be tracked by executing this processing with respect to all the characteristic points contained in the template.

In the meantime, the characteristic points 2a through 2i are simultaneously detected in the current image. If a new characteristic point other than the characteristic points being tracked from the previous image is detected, the new characteristic point is used as a tracking target in the next image frame. To this end, the positions of the respective characteristic points tracked from the previous image and the position of the newly-detected characteristic point in the current image are stored as a template in the memory of controller 103.

Pieces of velocity information regarding the characteristic points tracked in this manner, namely the moving speed (image velocity) and the moving direction (velocity direction), are computed. That is, the direction and the amount of movement of the characteristic points in the image are computed based on the positions of the characteristic points in the previous image and the positions of the characteristic points in the current image. When the pickup image is expressed in the form of an XY coordinate system, for example, the amount of movement can be computed based on the change in the coordinate values. Then, the image velocities of the characteristic points can be computed by dividing the computed amount of the movement of the characteristic points by the pickup time interval (Δt) of camera 101, and the velocity directions can be computed based on the changes in the coordinate values.

Next, the respective characteristic points are grouped into multiple characteristic points with the same time to collision (TTC), that is, the time until vehicle collision with the points. As described herein, the grouping of characteristic points with the same TTC is realized by taking advantage of the tendency for the image velocities of the characteristic points in the image to be proportional to the distances between the characteristic points and their vanishing points, and for the velocity directions to be equal to the directional vectors from the vanishing points to the characteristic points while the vehicle is traveling forward.

In other words, as shown in FIG. 3, assume the vanishing point is denoted by 3a, the positional vector of a characteristic point in an image is denoted by p, the focal distance of camera 101 is denoted by f, the distance to the characteristic point in real space is denoted by L, and the positional vector of the characteristic point in real space is denoted by P. In this case, the following relational expression given as Formula (1) holds.
p=(f/L)P (1)

The image velocity of characteristic point p can be expressed by Formula (2) given below by differentiating Formula (1) by time t.
dp/dt=fvP/L²=(v/L)p (2)

It is clear from Formula (2) that the image velocity of characteristic point p is proportional to the size of positional vector P, and the velocity direction is equal to the direction of vector p.

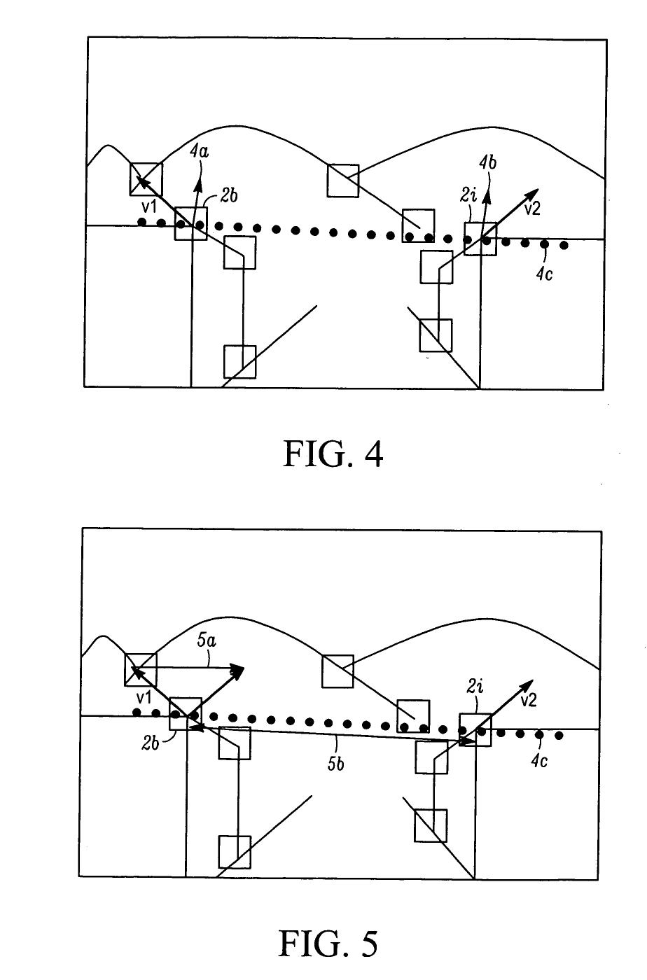

Using this tendency, a set comprising two characteristic points with the same TTC is extracted from the respective characteristic points. More specifically, the following processing is carried out. As shown in FIG. 4, assume velocity vectors computed based on the image velocities of characteristic point 2b (with positional vector p1) and characteristic point 2i (with positional vector p2) and their velocity directions are denoted by v1 and v2, for example. The velocity vectors v1 and v2 can be expressed by Formulas (3) and (4) given below by applying common variable α to Formula (2).
v1=αp1 (3)
v2=αp2 (4)

When the difference between the velocity vectors at the two characteristic points is computed using Formulas (3) and (4), Formula (5) given below emerges.
v2−v1=α(p2−p1) (5)

As such, when variable α equivalent to (v/L) in Formula (2) is common to Formulas (3) and (4), that is, when characteristic point 2b and characteristic point 2i are both present at the same distance from the vehicle, and their relative velocities with respect to the vehicle are the same, the difference in the velocity vectors v2−v1 is parallel to the vector that connects the two characteristic points 2b and 2i.

In this manner, a set of characteristic points with common variable α, that is, v/L, can be extracted from all the 2-characteristic point sets present in the image by extracting a set in which the difference between the velocity vectors of the two characteristic points is parallel to the vector connecting the two points. Here, because v/L is obtained by dividing the distances between the vehicle and characteristic point 2b and characteristic point 2i in real space by their relative velocities with respect to the vehicle, v/L indicates the times until vehicle collision with characteristic point 2b and characteristic point 2i, that is, the TTCs. Therefore, two characteristic points with the same α can be determined to be a set of characteristic points with the same TTC, and the characteristic points in the set in which the difference between the velocity vectors of the two characteristic points is parallel to the vector connecting the two points can be determined to be a set comprising two characteristic points with the same TTC.

In order to extract a set in which the difference between the velocity vectors of two characteristic points is parallel to the vector connecting the two points, as shown in FIG. 4, vector 4c connecting the two characteristic points and velocity vectors 4a and 4b in the perpendicular direction at the two characteristic points are computed. When the sizes of velocity vectors 4a and 4b in the perpendicular direction match, the two characteristic points, here 2b and 2i, are determined to have the same TTC, and a group of two characteristic points with the same TTC is obtained. This processing is applied to all the 2-characteristic point sets in order to divide them into multiple groups comprising characteristic points with the same TTCs.

Next, out of the characteristic point groups with the same TTCs that were obtained through this processing, a group of characteristic points present at a prescribed distance or farther away from the vehicle, that is, a distant candidate group, is extracted as target characteristic points to be monitored in order to detect pitching and yawing of the vehicle. In general, because the farther away the TTC is from the vehicle, the greater it becomes, a distant candidate group is extracted in the following manner.

Difference v2−v1 between the velocity vectors of characteristic point 2b and characteristic point 2i expressed in Formula (5) can be expressed using Formula (6) given below, based on the content described above, and this can be further modified into Formula (7).
v2−v1=v/L(p2−p1) (6)
v2−v1=(p2−p1)/TTC (7)

The difference between the velocity vectors of characteristic point 2b and characteristic point 2i with the same relative velocity with respect to the vehicle is the value obtained by dividing the difference between the positional vectors by the TTC. It is clear from Formula (7) that the smaller the difference v2−v1 between the velocity vectors of the two characteristic points compared to difference p2−p1 between the positional vectors of the two characteristic points, the greater the TTC. That is, as shown in FIG. 5, difference 5a between the velocity vectors in a set comprising two characteristic points 2b and 2i with the same TTC is computed. If difference 5a between the velocity vectors relative to distance 5b between the two points expressed by Formula (8) given below is smaller than a prescribed value, the set of characteristic points 2b and 2i with the same TTC can be determined to be characteristic points that are far away.
(dp2/dt−dp1/dt)/(p2−p1)=v/L (8)

Therefore, the distant candidate group can be extracted by applying the processing to an arbitrary 2-characteristic point set within a characteristic point group with the same TTC to determine whether the characteristic group is far away. Here, there is a possibility that detected characteristic points of a nearby moving object, such as a preceding vehicle whose relative positional relationship with the vehicle does not change, may be included in the distant candidate group extracted through the processing. That is, because a moving object whose relative positional relationship with the vehicle does not change is never affected by the direction the vehicle travels, no difference in velocity is observed among detected characteristic point sets of such a moving object.

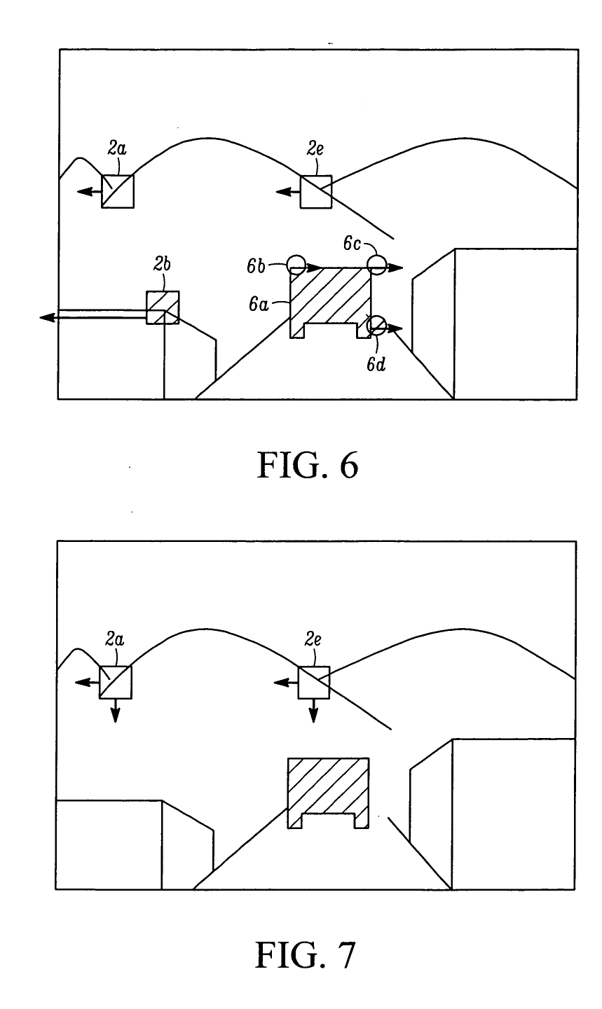

In addition, there is also a possibility that when the TTCs of a distant object and a nearby object match by coincidence during the grouping of characteristic points with the same TTCs, the characteristic point groups may be extracted as a distant characteristic group while the detected characteristic points of the nearby object are included therein. More specifically, as shown in FIG. 6, a case in which a group comprising detected characteristic points 6b through 6d of preceding vehicle 6a is extracted as a distant candidate group, and a case in which detected characteristic point 2b of a nearby object is grouped into the same distant candidate group with 2a and 2e that are far away are both plausible.

In order to eliminate such erroneous extractions, the following processing is performed. First, in general, a nearby moving object is very likely to be present at a lower part of the image, for example, in the bottom third of the end of the image. Thus, characteristic points positioned in a specific range of area from the bottom end of the image are extracted from each respective distant candidate group, and pieces of velocity information regarding these characteristic points and pieces of velocity information regarding other characteristic points, that is, characteristic points present at an upper part of the image within the same distant candidate group are compared. As a result, if the pieces of velocity information regarding the characteristic points that are present at the lower part of the image and the pieces of velocity information regarding the other characteristic points within the same distant candidate group are identical, they are all determined to be nearby moving objects, and the entire group is deleted from the distant candidate group. As a result, the distant candidate group containing detected characteristic points 6b through 6d of preceding vehicle 6a in FIG. 6 can be deleted.

However, if the pieces of velocity information regarding the characteristic points that are present at the lower part of the image and the pieces of velocity information regarding the other characteristic points within the same distant candidate group are different, a decision is made that only the characteristic points positioned at the lower part of the image are of a nearby moving object, and the other characteristic points are distant characteristic points. The characteristic points positioned at the lower part of the image are deleted from the distant candidate group. As a result, out of characteristic points 2a, 2b and 2e contained in the same distant candidate group, only characteristic point 2b detected of the nearby object can be deleted from the group. Here, although lateral movement velocities of the respective characteristic points are exemplified as image velocities to be compared in the example shown in FIG. 6, the actual image velocities or longitudinal image velocities may also be used for comparison.

Only a distant candidate group containing distant characteristic points can be designated as a distant group through the described processing. Then, pitching and yawing of the vehicle are detected by measuring, or monitoring, the movement of the distant characteristic points contained in the designated distant group. That is, because the distant characteristic points are at sufficiently long distances L from the vehicle in comparison to distance ΔL that the vehicle travels forward, they are little affected in the image by the forward movement of the vehicle. Hence, the movement of distant characteristic points in the image can be considered attributable to pitching and yawing of the vehicle.

Accordingly, the movement of the distant points is measured based on the directions in which the characteristic points move and their moving velocities in order to detect the pitching and the yawing of the vehicle. For example, as shown in FIG. 7, when distant characteristic points 2a and 2e move in the vertical direction in the image, a decision can be made that the vehicle is yawing sideways while pitching in the vertical direction.

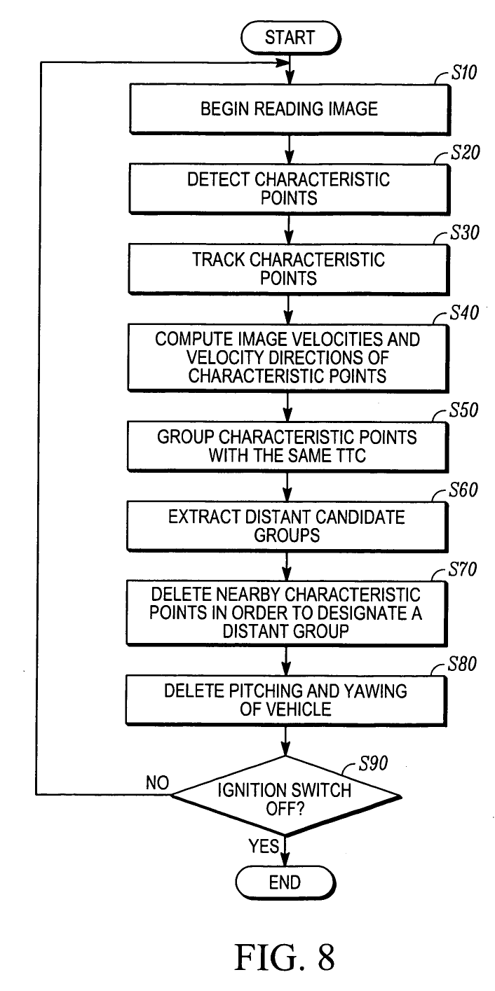

FIG. 8 is a flow chart showing the processing carried out by vehicular behavior detector 100. The processing shown in FIG. 8 is executed by controller 103 using a program activated when vehicular behavior detector 100 is powered via turning on the vehicle installed with vehicular behavior detector 100 with an ignition switch (not shown). In step S10, the reading of an image captured continuously by camera 101 is initiated, and advancement is made to step S20. In step S20, edge extraction processing is applied to the read image in order to detect end-points of extracted edges as characteristic points. Subsequently, processing advances to step S30.

In step S30, as described above, tracking is applied to the respective detected characteristic points. Next, in step S40, the image velocities and velocity directions of the respective characteristic points in the image are computed based on the tracking results of the respective characteristic points. Subsequently, upon advancing to step S50, characteristic points with the same TTC are grouped based on the computed image velocities and the velocity directions as described above. Processing next advances to step S60, where the distant candidate groups are extracted from the grouped characteristic points with the same TTC.

In the next step, step S70, distant candidate groups comprising nearby characteristic points are deleted and/or nearby characteristic points are deleted from a distant candidate group containing nearby characteristic points in order to designate a distant characteristic point group. Subsequently, upon advancing to step S80, the movements of the characteristic points contained in the designated distant group are measured in order to detect the pitching and the yawing of the vehicle. Processing then advances to step S90.

In step S90, whether or not the ignition switch has been turned off is determined. If it is determined that the ignition switch has not been turned off, the processing is repeated upon returning to step S10. In contrast, if a determination is made that the ignition switch has been turned off, the processing ends.

Accordingly, the following effects can be achieved. Characteristic points are detected within the pickup image, and only those which are far away (distant characteristic points) are extracted from the characteristic points. Then, the movements of the distant characteristic points are measured in order to detect the pitching and yawing of the vehicle. As a result, the pitching and yawing of the vehicle can be detected very accurately by monitoring the distant characteristic points that are little affected by the forward movement of the vehicle in the image.

In order to eliminate erroneous extraction of groups containing distant characteristic point candidates, that is, distant candidate groups, characteristic points that are present in a prescribed range of area from the bottom end of the image can be extracted. These characteristic points are determined to have been detected for a nearby object and are processed accordingly. As a result, detected characteristic points of a nearby object can be identified easily and very accurately based on the tendency for a nearby moving object to be normally present at a lower part of the image.

To eliminate erroneous extraction of distant candidate groups, when pieces of velocity information regarding characteristic points positioned within a prescribed range of area from the bottom end of the image are identical to pieces of velocity information regarding the other characteristic points within the same distant candidate group, a decision is made that they all represent a nearby moving object. Then, the entire group is deleted from the distant candidate group. As a result, a distant candidate group comprising detected characteristic points of a nearby object can be deleted reliably.

In addition to the foregoing, when pieces of velocity information regarding characteristic points positioned within a prescribed range of area from the bottom end of the image are different from pieces of velocity information regarding the other characteristic points within the same distant candidate group, a decision is made that only the characteristic points positioned at the lower part of the image are of a nearby moving object, and that the other characteristic points are distant characteristic points. This allows deletion of only the characteristic points positioned at the lower part of the image from the distant candidate group. As a result, when nearby characteristic points and distant characteristic points are contained in the same distant candidate group, only the nearby characteristic points are deleted from the group reliably.

Modifications of the features taught herein are also possible. For example, although an example in which the SAD technique is used for tracking the characteristic points was explained above, this does not impose a restriction. Other known techniques can be used to track the characteristic points.

The directions and the amount of movement of the characteristic points were computed above based on the positions of the characteristic points in the previous image and the positions of the characteristic points in the current image. Again, this does not impose a restriction. Image velocities of the characteristic points may be computed through the computation of known optical flow, for example.

As described herein, images in front of the vehicle are captured using camera 101, and the behavior of the vehicle is detected based on the images in front of the vehicle. However, camera 101 can also be set to capture images behind the vehicle, and the behavior of the vehicle can also be detected based on images captured behind the vehicle by camera 101.

This application is based on Japanese Patent Application No. 2005-161438, filed Jun. 1, 2005, in the Japanese Patent Office, the entire contents of which are hereby incorporated by reference.

The present invention is not by any means restricted to the configuration of the aforementioned embodiment as long as the characteristic functionality of the present invention is not lost. More specifically, the above-described embodiments have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A behavior detector for a vehicle, comprising:
an image pickup device for sequentially capturing a plurality of images outside the vehicle; and
a controller operable to extract characteristic points from each of the plurality of images, to compute movement information for the characteristic points moving through the plurality of images, to compute a time until collision of the vehicle with each of the characteristic points based on the movement information, and to designate certain of the characteristic points at distant positions from the vehicle as distant characteristic points using the respective times until collision; and wherein movements of the distant characteristic points indicate behavior of the vehicle.

2. The behavior detector according to claim 1 wherein the controller is further operable to separate characteristic points with identical times until collision into groups, to designate characteristic points having a time until collision equal to or greater than a prescribed value out of the groups as candidates for the distant characteristic points; and to delete nearby characteristic points for objects present near the vehicle from the candidates; and wherein remaining ones of the candidates are the distant characteristic points.

3. The behavior detector according to claim 2 wherein the nearby characteristic points comprise characteristic points present within a prescribed range from a bottom end of the image that are candidates.

4. The behavior detector according to claim 3 wherein the nearby characteristic points further comprise other candidates having the same movement information as the characteristic points present within the prescribed range from the bottom of the image that are candidates.

5. The behavior detection method according to claim 2 wherein the controller is further operable to determine movement information for characteristic points present within a prescribed range from a bottom end of an image and to determine movement information for characteristic points in an upper end of an image; and wherein the nearby characteristic points deleted include characteristic points present within the prescribed range from the bottom end of the image when the movement information for the characteristic points is not equal to the movement information for the characteristic points in the upper end of the image and wherein the nearby characteristic points deleted include the characteristic points present within the prescribed range from the bottom end of the image and the characteristic points in the upper end of the image when the movement information for the characteristic points present within the prescribed range from the bottom end of the image is equal to the movement information for the characteristic points in the upper end of the image.

6. The behavior detector according to claim 1 wherein the behavior comprises at least one of a pitch and a yaw of the vehicle.

7. The behavior detector according to claim 1 wherein the movement information comprises at least one of a velocity and a direction for each of the characteristic points.

8. A behavior detector for a vehicle, comprising:
pickup means for capturing images external of the vehicle;
characteristic point extraction means for extracting characteristic points out of images captured by the pickup means;
velocity information computation means for computing pieces of velocity information regarding each of the characteristic points extracted by the characteristic point extraction means;
time-until-collision computation means for computing respective times until vehicle collision with each of the characteristic points based on the pieces of velocity information computed by the velocity information computation means; and
designation means for designating characteristic points present at distant positions from the vehicle based on the respective times computed by the times-until-collision computation means wherein vehicular behavior is based on movements of the distant characteristic points designated by the designation means.

9. The behavior detector according to claim 8 wherein the designation means further comprises means for separating characteristic points with identical time-until-collision into groups, means for designating characteristic points showing times-until-collision equal to or greater than a prescribed value out of the groups as candidates for the distant characteristic points; and means for deleting nearby characteristic points for objects present near the vehicle from the candidates wherein remaining ones of the candidates are the distant characteristic points.

10. The behavior detector according to claim 9 wherein the means for deleting nearby characteristic points further comprises designating characteristic points present within a prescribed range from the bottom end of the image that are candidates as the nearby characteristic points.

11. The behavior detector according to claim 10 wherein the designation means further comprises means for designating other candidates having the same pieces of velocity information as the nearby characteristic points as nearby characteristic points.

12. The behavior detector according to claim 8 wherein the vehicular behavior comprises at least one of a pitch and a yaw of the vehicle.

13. The behavior detector according to claim 8 wherein the pieces of velocity information comprise at least one of a velocity and a direction for each of the characteristic points.

14. A behavior detection method for a vehicle, comprising:
sequentially capturing a plurality of images outside the vehicle;
extracting characteristic points from each of the plurality of images;
computing movement information for the characteristic points moving through the plurality of images;
computing a time until collision of the vehicle with each of the characteristic points based on the movement information; and
designating certain of the characteristic points at distant positions from the vehicle as distant characteristic points using the respective times until collision; and wherein movements of the distant characteristic points indicate behavior of the vehicle.

15. The behavior detection method according to claim 14 wherein designating certain of the characteristic points as distant characteristic points further comprises separating the characteristic points having a same time until collision into respective groups, selecting at least one of the respective groups as a distant candidate group wherein the at least one of the respective groups has a time until collision equal to or greater than a prescribed value, and deleting characteristic points for objects present near the vehicle from the distant candidate group; and wherein the remaining characteristic points of the distant candidate group are the distant characteristic points.

16. The behavior detection method according to claim 15 wherein deleting characteristic points for objects present near the vehicle from the distant candidate group further comprises deleting characteristic points present within a prescribed range from a bottom end of an image from the distant candidate group.

17. The behavior detection method according to claim 16, further comprising:
deleting characteristic points having a same movement information as the characteristic points present within the prescribed range from the bottom end of the image from the distant candidate group.

18. The behavior detection method according to claim 15, further comprising:
determining movement information for nearby characteristic points present within a prescribed range from a bottom end of an image; and
determining movement information for characteristic points in an upper end of an image; and wherein deleting characteristic points for objects present near the vehicle from the distant candidate group further comprises deleting the nearby characteristic points when the movement information for the nearby characteristic points is not equal to the movement information for the characteristic points in the upper end of the image and deleting the nearby characteristic points and the characteristic points in the upper end of the image when the movement information for the nearby characteristic points is equal to the movement information for the characteristic points in the upper end of the image.

19. The behavior detection method according to claim 14 wherein the behavior of the vehicle comprises at least one of a pitch and a yaw of the vehicle.

20. The behavior detection method according to claim 14 wherein the movement information for the characteristic points comprises at least one of a velocity and a direction of each of the characteristic points.
